(19) United States
(12) Patent Application Publication
(10) Pub. No.: US 2004/0062922 A1
(43) Pub. Date: Apr. 1, 2004

(54) Composite product and method for manufacturing the composite product

(76) Inventor: Leif Sunde, Alesund (NO)

Correspondence Address: JACOBSON HOLMAN PLLC, 400 SEVENTH STREET N.W., SUITE 600, WASHINGTON, DC, 20004, US

(21) Appl. No.: 10/451,800

(22) PCT Filed: Dec. 10, 2001
(86) PCT No.: PCT/NO01/00489

(30) Foreign Application Priority Data
Jan. 15, 2001 (NO) 20010254

(51) Int. Cl. B29C 44/12; A47C 7/18; B32B 3/26; B32B 27/00

(52) U.S. Cl. 428/319.3; 264/46.4

(57) ABSTRACT

A method for manufacturing a composite product, such as a furniture element, where a core is encapsulated in and enveloped by a foamed plastic material (3) in a mould (4). The composite product is manufactured by using as a core (1) a supporting element, which is either integrated in the composite product or removed after the moulding of the product is completed. Alternatively the core (1) may be composed of support elements in the mould. Furthermore, there may be attached to the core a covering plate (2) made of a plastic material with greater density than the foamed plastic envelop (3) and the covering plate (2) may be enclosed by foamed plastic (3) by means of moulding. The invention further comprises a moulded composite product, for example a furniture element. The composite product comprises a plate-shaped rigid core (1) encapsulated in a body of foamed plastic by fixing to the core at least one covering plate (2) of plastic material, which has greater density than the surrounding foamed plastic material (3).

The present invention relates to a method for manufacturing a composite product, which may preferably be used as a furniture element such as, e.g., the seat and/or back of a chair. The invention also relates to the actual composite product and its construction.

It is well known in the prior art to manufacture a composite product, which is intended for use as a furniture element, by moulding in a form or forming. In such a moulding process use is made of a core, which is encapsulated in foamed plastic material. The core is placed in a mould and chemicals, which react to form the foamed plastic material, are dispensed in the mould and caused to foam. The foam mixture expands surrounding the core until the foam fills the mould and the finished composite product emerges.

In this connection we refer to the following publications:

U.S. Pat. Nos. 5,542,747 and 5,400,490 both disclose a car seat where a frame element with a support element are moulded in a manner resulting in a foamed plastic material with a density that is lower than the density of the frame element and the support element.

JP 06182915 discloses a cushion made of polyurethane foamed material with an integrated layer, where the material forming this layer has lower elasticity than the surrounding foamed material.

The foamed plastic material included in the composite product is often polyurethane foamed plastic, but other types of foamed plastic materials may also be used. The core that forms part of the composite product will often be a supporting element such as a rigid plate-shaped body made, for example, of wood, metal or plastic. It will be up to a person skilled in the art to decide which type of core material is best suited in the individual case.

The object of the present invention is to reduce the portion of polyurethane foamed plastic in the finished composite product, thereby achieving both environmental and financial benefits. The portion of polyurethane foamed plastic in the finished composite product can be reduced by replacing a part of the foamed plastic with another suitable filling material. When the need for manufacturing polyurethane foamed plastic declines, the strains on the environment are consequently reduced with the decline of the emissions into the atmosphere and the reduction in the use of chemicals. This is both favourable for the environment and economical for the manufacturer. The chemicals employed in manufacturing polyurethane foamed plastic are expensive and a reduction in the costs in this part of the process will lead to substantial savings in relation to the total cost of manufacturing the entire composite product.

When composite products are manufactured in which polyurethane foamed plastic is employed as the foamed plastic material, a certain amount of carbon dioxide is liberated, which is discharged into the atmosphere. During the manufacture of polyurethane foamed plastic the formation of carbon dioxide is part of the process and produces foaming of the material. The amount of carbon dioxide formed in the manufacturing process has a direct connection with the density of the completed foamed plastic material. If it is desirable to have a polyurethane foamed plastic with a low weight and large volume, this requires the addition of large quantities of carbon dioxide. In this case it will be necessary to use large quantities of carbon dioxide, and therefore the carbon dioxide emissions into the environment will be greater, thus causing greater strains on the environment.

Since it has been found that particularly favourable conditions are obtained with regard to costs and the environment by replacing a part of the polyurethane foamed plastic with another less expensive and more environmentally friendly alternative, it should be emphasized that many different types of the material will be suitable as a filler according to the invention. This filling material may be composed of ready-produced foamed plastic of a quality that corresponds to or is different from polyurethane foamed plastic. Remnants after processing of foamed plastic materials, discarded foamed plastic products, various types of foamed plastic, which are glued together or joined in some other way to form a body, as well as various types of plastic materials will also be suitable as filling material in the covering element.

Compared with a traditionally manufactured furniture element, therefore, by means of the manufacturing method described herein the object will be achieved that a furniture element can be manufactured that is both more environmentally friendly and cost competitive.

It is therefore an object of the present invention to specify a method for manufacturing a composite product such as a furniture element, in which a core is moulded encapsulated, and enveloped by a foamed plastic material in a mould. The method is further characterised in that as a core a supporting element is employed which is either integrated in the composite product or removed. Alternatively, the core may be composed of support elements in the mould. Furthermore, a covering plate is attached to the core, where the covering plate is made of a recyclable material. The covering plate is enveloped by foamed plastic material by means of moulding. Further embodiments of the method for manufacturing the composite product are set forth in the dependent patent claims 2-7.

A further object of the present invention is to provide a moulded composite product, for example a furniture element, with a plate-shaped rigid core encapsulated in a body of foamed plastic material. The composite product is characterised in that at least one covering plate made of recyclable material is attached to the core. For further embodiments of the composite product reference should be made to the dependent claims 9-10.

According to the present invention the composite product will also be able to be manufactured by means of moulding. For this purpose a core is employed, which may be a rigid plate-shaped part made of wood, metal or plastic or another suitable material to which a covering element is attached. The covering element consists of a filling material that may consist of any type of plastic. The covering element is attached to the core by gluing, for example point gluing. Here it will be obvious to a person skilled in the art that other suitable types of fixing methods may be employed for preventing movement between the core and the covering element during moulding. The core with the covering element is placed in a mould and a foamed product is dispensed in the mould. The foamed product expands and becomes attached in an enveloping manner to the covering plate and parts of the core. The covering element will preferably be of a size corresponding to the size of the core. When the foamed product has expanded and filled the moulding tool, a finished product will be formed in which the polyurethane foam substantially forms the outer walls of the composite product and the core and the covering material constitute the bulk of the interior of the composite product.

In a preferred embodiment of the invention the covering element will be composed of a plastic material with a density that is greater than the density of the surrounding plastic material. In a specially environmentally friendly version the covering element may be made of recyclable material, the material composition for the covering element could various as described above. What is important, however, is that the covering plate is compatible with the surrounding foamed plastic material. This means that it is crucial for the finished composite product that a satisfactory attachment should be obtained between the covering element and the surrounding foamed plastic material.

It will also be possible to vary the density and thereby the hardness of the foamed plastic enveloping the core and the covering material by varying the chemical admixture in the foamed plastic production.

The hardness of the core and the covering plate can be varied in such a manner that the composite product is produced with material properties that are preferred within the area of application in which the product is to be used.

If desirable it will be possible within the scope of the invention to manufacture a composite product equipped with a core where a covering element is attached on both sides of the core. Foamed plastic material can be arranged in such a manner that it completely envelops the covering elements. If the completed furniture element requires to be equipped with reversible elements, whose sides are of different degrees of hardness, the two covering elements may be composed of two different materials or of the same materials but of different hardness.

The plastic material enveloping the core and the covering plate is preferably of the polyurethane foamed plastic type. Polyurethane foamed plastic is manufactured by reactants polyether polyol and isocyanate being mixed together and dispensed in moulds with the addition of water. As a reaction between isocyanate and water, carbon dioxide will be formed, causing foaming of the foam mixture. The amount of water added in this phase is crucial for the amount of carbon dioxide developed. The presence of large amounts of carbon dioxide is crucial if it is desirable to develop a foam that will be light. In moulding, small amounts of chemicals are discontinuously dispensed in moulds. The volume of the dispensed chemicals increases approximately 30 times. The reaction starts after 5-7 seconds and the expansion of the cushions is complete after 5 minutes.

In a preferred embodiment the furniture element will be used as a chair seat. The core then constitutes the bottom of the chair seat to which the chair's framework can be attached. The composite product or the furniture element will then preferably be produced so that a surface of the core substantially has no foamed plastic exposed to the environment.

For another application of the furniture element it will also be possible to employ a steel material in the core, thus obtaining a direct encapsulation, e.g. of a flexible steel element for use as a neck support.

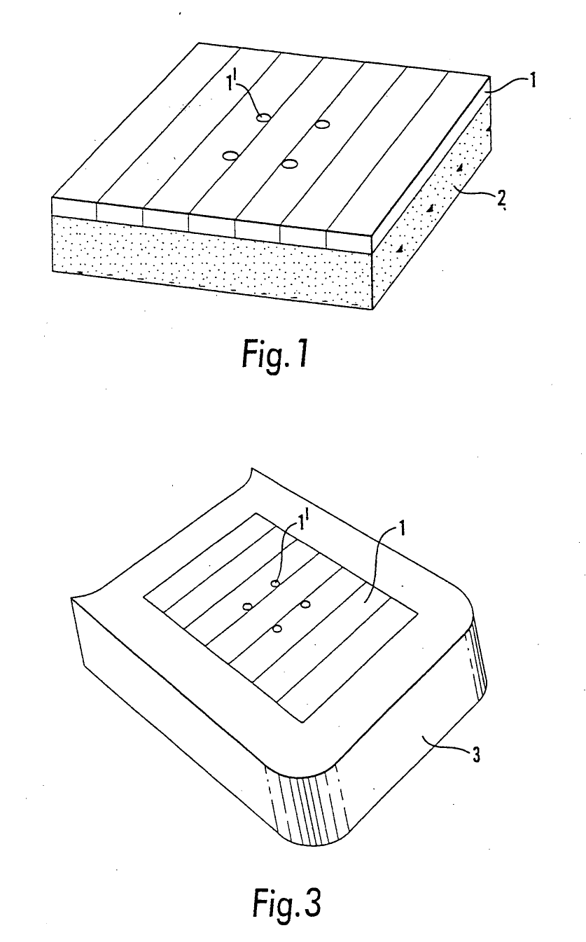

FIG. 1 illustrates an overview of the core with covering element before encapsulation.

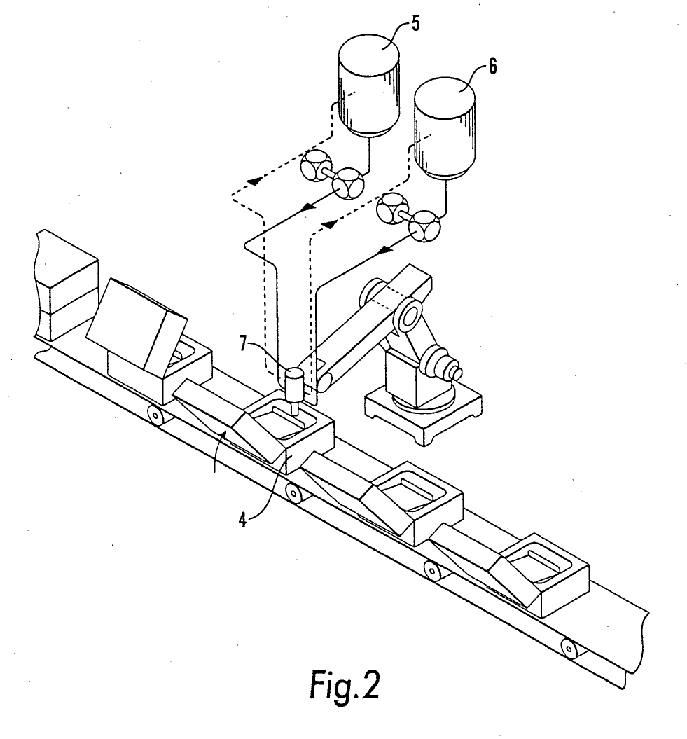

FIG. 2 illustrates the actual equipment required for the moulding process.

FIG. 3 illustrates the composite product on completion of the moulding process.

FIG. 1 illustrates the core 1 attached to a covering material 2 before these parts are placed in the forming tool for moulding. The figure shows that the core 1 is adapted to the surface of the covering material 2. In this embodiment the core 1 is equipped with through-going holes, these holes 1′ being arranged for attachment to the framework of a chair.

FIG. 2 illustrates a moulding plant. The forming tools are illustrated arranged on a conveyor belt. The arrangement of the covering plate and core 1 illustrated in FIG. 1 will be placed in a forming tool 4 as illustrated in FIG. 2. As illustrated in the figure, polyether polyol and isocyanate will each be transferred from its container 5 and 6 respectively to a mixing chamber 7 where the reactants are blended. From the mixing chamber the chemicals are dispensed into the forming tool 4. In the forming tool, with the addition of water the mixture will foam up around the covering plate 2 and also the core 1 to some extent. The foam mixture, however, will not completely covering the surface of the core 1. It is the carbon dioxide that is formed as a reaction between isocyanate and water that causes this foaming of the foam product.

When the moulding process is completed, the product will appear as shown in FIG. 3. The covering element is not illustrated here, since it is encapsulated in the foamed plastic material. The core 1 and the covering plate 2 together with the surrounding outer walls of polyurethane foamed material 3 form the completed composite product.

The manufacture of the composite product is explained according to the preferred embodiment of the invention with regard to the manufacture of polyurethane foamed plastic. It is obvious that other types of foamed plastic material, which can be combined with the covering plate and the core will be suitable for use as an enveloping material in the composite product.

In a further embodiment of the invention it may be appropriate to allow components which form part of the mould to act as a core during moulding of the composite product. In this case the covering element is mounted directly on to those of the mould's components that are suitable for use as a core, for example the mould may be equipped with upwardly projecting elements where studs or spikes arranged on the ends of the elements are well suited as securing elements/support elements for the covering element. After the moulding of the composite product is completed, it is released from the mould's securing elements. In this embodiment the composite product will comprise a covering plate and enveloping material of foamed plastic.

1. A method for manufacturing a composite product, such as a furniture element, where a core is encapsulated in and surrounded by a foamed plastic material in a mould, characterised in that as a core a supporting element is employed, which is either integrated in the composite product or removed, or alternatively the core may be composed of support elements in the mould, in addition to which there is attached to the core a covering plate made of a recyclable material and the covering plate is enveloped by foamed plastic material by means of moulding.

2. A method for manufacturing a composite product according to claim 1, characterised in that the covering plate is made of recyclable material, such as for example chopped up, discarded foamed plastic products, or remnants from processing of foamed plastic products.

3. A method for manufacturing a composite product according to claim 1 or 2, characterised in that on at least one side of the core is attached a covering plate of a plastic material, and that the covering plate and at least parts of the core are enveloped by foamed plastic by means of moulding, where the covering plate preferably has greater density than the foamed plastic material.

4. A method for manufacturing a composite product according to one of the claims 1-3, characterised in that on both sides of the core is attached a covering plate, where the two covering plates may be composed of two different materials or of the same material with different hardness.

5. A method for manufacturing a composite product according to one of the claims 1-4, characterised in that the core with the covering plate are placed in the mould and the reactants polyether polyol and isocyanate are blended in the mould with the addition of water, whereupon carbon dioxide is formed in the mixture as a reaction between isocyanate and water, thus causing a foaming as the foam mixture expands up around the covering plate and attaches thereto with the result that the composite product is produced with an outer wall of polyurethane foamed plastic.

6. A method for manufacturing a composite product according to one of the claims 1-5, characterised in that the covering plate is glued to the core by point gluing.

7. A method for manufacturing a composite product according to one of the claims 1-6, characterised in that the covering plate is of a size corresponding to the core's size.

8. A moulded composite product, for example a furniture element, with a plate-shaped rigid core encapsulated in a body of foamed plastic material, characterised in that at least one covering plate made of recyclable material is attached to the core.

9. A moulded composite product according to claim 8, characterised in that the covering plate has greater density than the foamed plastic material.

10. A moulded composite product according to claim 8 or 9, characterised in that the composite product should be a chair seat where one surface of the core forms the bottom of the chair seat.
